(19) United States
(12) Patent Application Publication
(10) Pub. No.: US 2007/0091507 A1
(43) Pub. Date: Apr. 26, 2007

(54) Load/unload ramp

(75) Inventors: Pow-Hing Yong, Singapore (SG); CheeFong Oh, Penang (MY); Samual SC Gan, Singapore (SG); LiHong Zhang, Singapore (SG); MuiChong Chai, Singapore (SG)

Correspondence Address: SHUMAKER & SIEFFERT, P. A., 1625 RADIO DRIVE, SUITE 300, WOODBURY, MN, 55125, US

(73) Assignee: Seagate Technology LLC, Scotts Valley, CA (US)

(21) Appl. No.: 11/258,968

(22) Filed: Oct. 26, 2005

(51) Int. Cl. G11B 5/54

(52) U.S. Cl. 360/254.8

(57) ABSTRACT

A disc drive utilizes ramp load unload technology. A ramp component of the disc drive includes a recess that reduces the contact surface area of the ramp component that supports an actuator assembly to unload a slider of the disc drive. The actuator assembly may include a lift tab that interacts with the ramp component to hold the slider off a media disc when the slider is unloaded.

### TECHNICAL FIELD

The present disclosure relates to data storage devices, particularly disc drives.

### BACKGROUND

Disc drives utilize ramp load/unload technology in which one or more sliders, which carry read/write heads, are moved off the disc prior to power-down by safely positioning them on a support structure. In some instances, an actuator arm may include a lift tab that rests directly on the support structure to hold the slider off the disc. Generally the support structure includes a shallow ramp on the side closest to the disk. During a power-on sequence, the slider is loaded by moving the slider off the ramp and over the disc surfaces when the discs reach the appropriate rotational speed.

As with all disc drives, the air current from the rotating disc acts like a cushion between the slider and the disc medium, keeping the two surfaces separated by a designed distance, referred to herein as the fly height. In addition to reducing the chance that an external shock may cause a read/write head to damage the data surface of a disc, ramp load/unload technology also allows for increases in areal density because stiction between the slider and disc surface is not an issue.

For at least these reasons, ramp load/unload technology is often preferred for disc drive design.

### SUMMARY

In general, the invention is directed to ramp load/unload techniques involving a ramp providing a reduced contact area with the actuator assembly. A ramp component of a disc drive includes a recess that reduces the contact surface area of the ramp component that supports an actuator arm of the disc drive. For example, the ramp component may provide a reduced contact area for a lift tab of the actuator assembly. The recess may be a groove between two halves of the contact surface area of the ramp component.

In one embodiment, the invention is directed to a disc drive comprising a media disc an actuator arm, a slider coupled to the actuator arm, and a ramp component forming a surface including a recess. The slider is unloaded when the actuator arm moves such that it is supported by the surface of the ramp component.

Embodiments of the invention may provide one or more of the following advantages. Embodiments of the invention may reduce the overall frictional force between the ramp and a lift tab. This may reduce power required to load and unload a slider of the disc drive and improve reliability of the disc drive. Embodiments of the invention may reduce the particle contamination inside the drive because the recess of ramp may act as a sink for particles when the lift-tab sliding back and forth from the ramp surface. Embodiment of the invention may also reduce the thermal expansion incompatibility of ramp and other drive components because the recess or groove also acts as an air gap.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is an illustration of a disc drive including a load/unload ramp providing a reduced contact area.

FIGS. 2A and B are close-up views of the load/unload ramp of the disc drive in FIG. 1.

### DETAILED DESCRIPTION

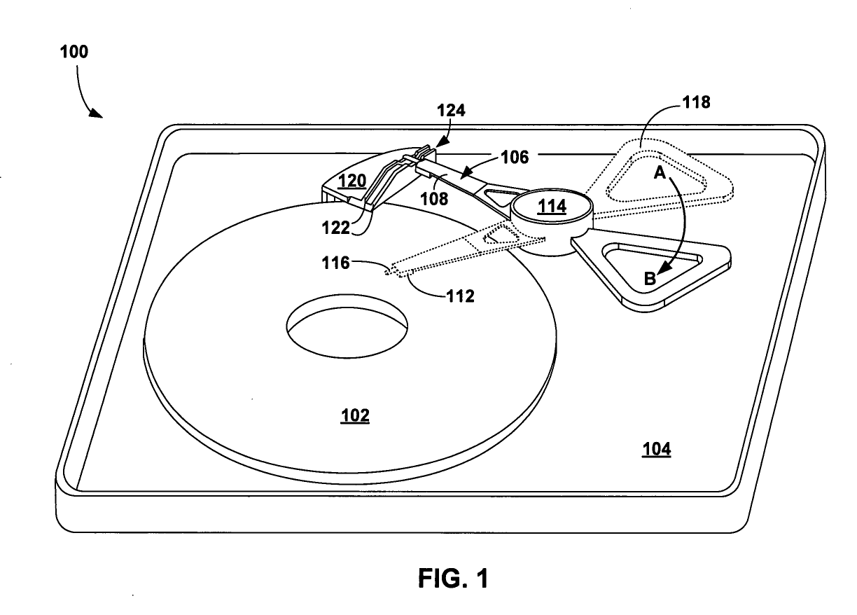

FIG. 1 is an illustration of disc drive 100 including load/unload ramp component 120 providing a reduced contact area according to an embodiment of the invention. Disc drive 100 includes a recordable media disc 102 mounted to base 104. For example, media disc 102 may be a magnetic disc, optical disc, magneto-optic disc or other data storage disc. Disc drive 100 also includes an actuator assembly 106, which pivots about bearing shaft assembly 114. Actuator assembly 106 includes actuator arm 108 and voice coil 118, which interacts with a permanent magnet (not shown) to rotate actuator assembly 106 about bearing shaft assembly 114. Rotating actuator assembly 106 about bearing shaft assembly 114 moves slider 112 across media tracks of disc 102. Slider 112 carries one or more read/write heads, which can record and retrieve data from the recordable surface of media disc 102.

Actuator assembly 106 is shown in two positions: A and B. As shown with position A, slider 112 is in a loaded position, and disc drive 100 may be performing a read or write operation. In contrast, position B shows slider 112 in an unloaded position. For example, actuator assembly 106 may rotate slider 112 into an unloaded position prior to a power-down of disc drive 110.

To reach an unloaded position, voice coil 118 interacts with a permanent magnet (not shown) to rotate actuator assembly 106 off media disc 102. As actuator assembly 102 reaches the outer diameter of media disc 102, lift tab 116 interacts with ramp component 120. Specifically, after lift tab 116 contacts surface 122 of ramp component 120, further rotation of actuator assembly 106 causes lift tab to slide up surface 122 of ramp component 120. Actuator arm 108 flexes vertically, allowing the rotation and slider 112 to be lifted from media disc 102. The rate at which slider 112 is lifted from media disc 102 is dependent on the slope of surface 122 relative to the data storage plane of media disc 102. For example, the initial slope of surface 122 may be between five and thirty degrees. For example, the initial slope of surface 122 may be about sixteen degrees.

In the final unloaded position B, lift tab 116 rests in a detent at the top of surface 122. The detent in surface 122 provides a semi-locked position for lift tab 116. This may secure actuator assembly 106 in position B even in the event of an external shock to disc drive 100.

Ramp component 120 forms groove 124 within surface 122. Groove 124 reduces the contact area between lift tab 116 and ramp component 120. The reduced contact area between ramp component 120 and lift tab 116 provided by groove 124 reduces the tangential frictional force from the interface of lift tab 116 and ramp component 120.

For example, the frictional force from the interface of lift tab 116 and ramp component 120 is partially the result of interface attraction forces such as van der Waals forces, electrostatic force forces etc. With interface attraction forces, reducing the contact surface area also directly reduces frictional force. Another reduction in the tangential friction forces comes from reduced obstacle force due to surface roughness like asperities on each of lift tab 116 and ramp surface 122.

For example, in some embodiments, lift tab 116 may be made from a harder material than ramp component 120. In such embodiments, asperities on surface 122 are subject to elastic deformation as lift tab 116 passes over them. Reducing the contact area at the interface between lift tab 116 and surface 122 reduces the obstacle force required to cause the elastic deformation of asperities on surface 122. In this manner, reduced contact area at the interface of lift tab 116 and ramp surface 122 reduces both attraction forces and the obstacle force, therefore reducing the overall tangential frictional force.

By reducing the tangential frictional force due to the interface between lift tab 116 and ramp surface 122, the power required to load and unload slider 112 is reduced. Furthermore, reduced frictional force due to the interface between lift tab 116 and ramp surface 122 may provide for more consistent and reliable loading and unloading of slider 112.

In an extreme scenario, tangential frictional force from the interface between lift tab 112 and ramp component 120 may actually result in actuator assembly 106 being stuck in a fixed position. If this occurs, disc drive 110 would be inoperable as the one or more read/write heads (not shown) on actuator assembly 106 could not interact with the media surface on media disc 102. Reducing the tangential frictional force reduces or eliminates the likelihood that actuator assembly 106 will become stuck with slider 112 in an unloaded position. Groove 124 may also provide the additional benefit as being a place that dust and other particles may settle without interfering with the operation of disc drive 100. In each of these ways, groove 124 may improve the reliability of disc drive 100.

Load/unload ramp 120 is shown on the outer diameter of media disc 102. In other embodiments, load/unload ramp 120 may be located near the center of media disc 102. In either configuration, benefits of utilizing ramp load/unload technology and the current invention are present.

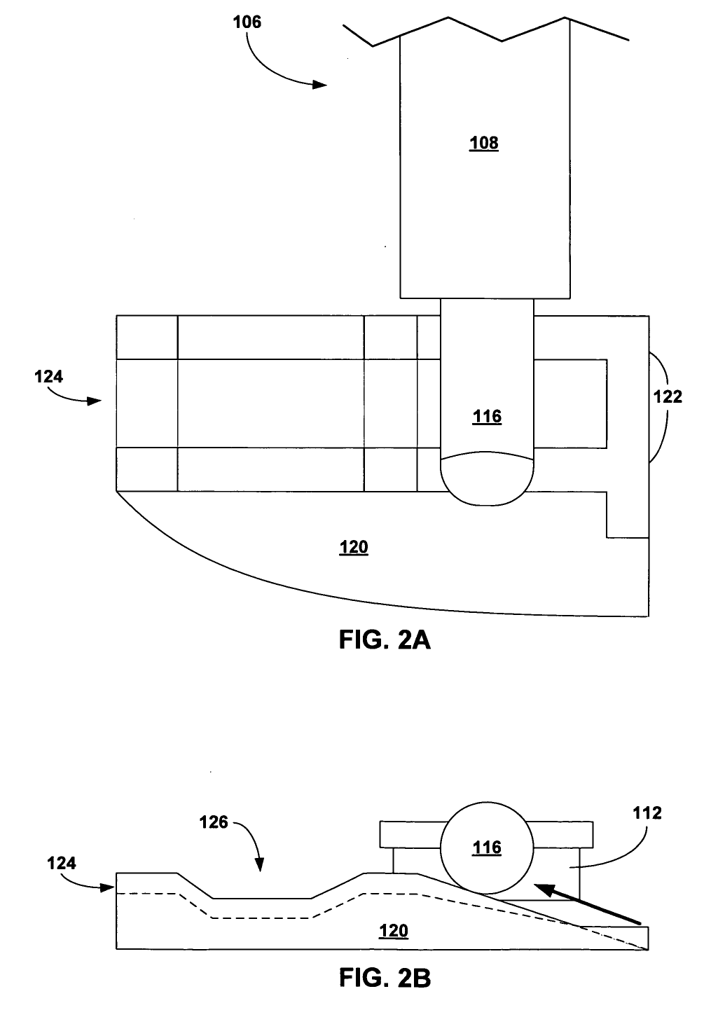

FIGS. 2A and B are close-up views of ramp component 120 of disc drive 100 from FIG. 1. Specifically, FIG. 2A is a top view of ramp component 120, lift tab 116 and actuator arm 108. FIG. 2B is a corresponding side view illustrating ramp component 120, lift tab 116 and slider 112.

In FIGS. 2A and B, slider 112 is shown in an unloaded position. As shown in FIG. 2B, lift tab 116 is in the process of sliding up surface 122 of ramp component 120. As disc drive 110 continues the unloading motion, lift tab will slide further up ramp surface 122. Eventually, lift tab 116 will reach detent 126 of ramp component 120 and actuator assembly 106 will be in a semi-locked position.

Lift tab 116 experiences a tangential frictional force opposing its direction of motion on ramp surface 122. Because lift tab 116 is attached to actuator arm 108, actuator assembly 106 also experiences this frictional force. In order to overcome the frictional force, additional power is required to move actuator assembly 106. However, the frictional force is reduced by the presence of groove 124 in ramp component 120. Groove 124 provides a reduced contact area at the interface of lift tab 116 and ramp surface 122 and reduces both attraction forces and the obstacle force, therefore reducing the overall tangential frictional force.

Groove 124 is recess formed within ramp surface 122. Ramp surface 122 includes two separate and substantially parallel halves and groove 124 is formed by ramp component 124 between the halves. In other embodiments, ramp component 120 may form a contiguous ramp surface, rather than two distinct portions as ramp surface 122 does. For example, ramp component 120 may form a plurality of recesses within a contiguous ramp surface. In other embodiments, ramp component 120 may include separate farts, each part forming a portion of a ramp surface. Consistent with principles of the invention, such embodiments would reduce the contact surface area at the interface between lift tab 116 and ramp component 120.

Various embodiments of the invention have been described. Nevertheless, it will be understood that various modifications may be made without departing from the spirit and scope of the invention. For example, a disc drive may include more than one media disc and/or more than one actuator arm and slider.

These and other embodiments are within the scope of the following claims.

1. A disc drive comprising:
a media disc;
an actuator arm;
a slider coupled to the actuator arm; and
a ramp component forming a surface including a recess, wherein the slider is unloaded when the actuator arm moves such that it is supported by the surface of the ramp component.

2. The disc drive of claim 1, further comprising a lift tab, wherein the lift tab is attached to an end of the actuator arm and interacts with the surface to unload the slider.

3. The disc drive of claim 1, wherein the surface is formed by two separate and substantially parallel half portions and the recess is a groove between the half portions.

4. The disc drive of claim 1, wherein the ramp component is positioned at an outer circumference of the media disc.

5. The disc drive of claim 1, wherein the surface includes a substantially flat portion that is at an angle of between ten and thirty degrees relative to a data storage plane of the media disc.

6. The disc drive of claim 5, wherein the substantially flat portion is at an angle of about sixteen degrees relative to the data storage plane.

7. The disc drive of claim 1, further comprising a detent at the top of the ramp component, wherein the actuator arm assumes a semi-locked position when it is supported by a portion of the ramp component forming the detent.

8. The disc drive of claim 7, wherein the disc drive assumes the semi-locked position prior to powering-down.
